(19) United States
(12) Patent Application Publication
(10) Pub. No.: US 2012/0165185 A1
(43) Pub. Date: Jun. 28, 2012

(54) Thermally Stable Catalyst Carrier Comprising Barium Sulfate

(75) Inventors: Gary A. Gramiccioni, Madison, AL (US); Kenneth R. Brown, Athens, AL (US); Michel Deeba, East Brunswick, NJ (US); Stefan Kotrel, Bedminster, NJ (US); Knut Wassermann, Princeton, NJ (US)

(73) Assignee: BASF Corporation, Florham Park, NJ (US)

(21) Appl. No.: 12/978,712

(22) Filed: Dec. 27, 2010

(51) Int. Cl. B01J 27/053; B01J 37/02; B01J 32/00

(52) U.S. Cl. 502/217; 502/439

(57) ABSTRACT

Provided herein is a barium sulfate-containing catalyst carrier. The catalyst carrier is useful for supporting an exhaust gas purification catalyst, such as a three way conversion catalyst. In an embodiment, the carrier comprises BaSO₄/thermally stable alumina. Further provided is a process for preparing the catalyst carrier, with or without precious metals, comprising treating a barium oxide/alumina or barium carbonate/alumina with a stoichiometric amount of sulfuric acid (H₂SO₄), thus forming BaSO₄/alumina in situ in good yield and at low cost.

### FIELD OF THE DISCLOSURE

The present materials and methods relate to a catalyst carrier including a barium sulfate layer, useful for supporting an exhaust gas purification catalyst. It further relates to a processes for preparing the catalyst carrier, including barium sulfate formation in situ within the porous support by treatment of barium-doped alumina with sulfuric acid, optionally followed by impregnation with precious metals.

### BACKGROUND

High temperature catalysts, such as three-way conversion (TWC) catalysts, are useful in industry. TWC catalysts have utility in a number of fields including the abatement of nitrogen oxide (NOx), carbon monoxide (CO) and hydrocarbon (HC), such as non-methane hydrocarbon (NMHC), emissions from internal combustion engines, such as automobile and other gasoline-fueled engines. TWC conversion catalysts are polyfunctional because they have the ability to substantially and simultaneously catalyze the oxidation of hydrocarbons and carbon monoxide, and the reduction of nitrogen oxides. Emissions standards for nitrogen oxides, carbon monoxide, and unburned hydrocarbon contaminants have been set by various government agencies and must be met by new automobiles.

In order to meet such standards, catalytic converters containing a TWC catalyst are located in the exhaust gas stream of internal combustion engines. Catalytic converters are one type of an exhaust emission control system, and comprise one or more catalytic materials deposited on a substrate. The composition of the catalytic materials, the composition of the substrate, and the method by which the catalytic material is deposited on the substrate are bases by which catalytic converters can be differentiated from one another. Methods of depositing catalytic materials onto a substrate include washcoating, imbibing, impregnating, physisorbing, chemisorbing, precipitating, and combinations comprising at least one of the foregoing deposition methods.

TWC catalysts exhibiting good activity and long life comprise one or more platinum group metals, e.g., platinum, palladium, rhodium, ruthenium, and iridium. These catalysts are employed with a high surface area refractory oxide support. The refractory metal oxide can be derived from aluminum, titanium, silicon, zirconium, and cerium compounds, resulting in the oxides with the exemplary refractory oxides including at least one of alumina, titania, silica, zirconia and ceria. The TWC catalytic support is carried on a suitable carrier or substrate such as a monolithic carrier comprising a refractory ceramic or metal honeycomb structure, or refractory particles such as spheres or short, extruded segments of a suitable refractory material.

Alumina (Al₂O₃) is a known support for many catalyst systems. Alumina has a number of crystalline phases such as alpha-alumina (often noted as α-alumina or α-Al₂O₃), gamma-alumina (often noted as γ-alumina or γ-Al₂O₃) as well as a myriad of alumina polymorphs. Gamma-alumina is a transition alumina. Transition aluminas are a series of aluminas that can undergo transition to different polymorphs. Santos et al. (Materials Research, 2000; 3 (4): 104-114) disclosed the different standard transition aluminas using electron microscopy studies, whereas Zhou et al. (Acta Cryst., 1991, B47: 617-630) and Cai et al. (Phys. Rev. Lett., 2002, 89: 235501) described the mechanism of the transformation of gamma-alumina to theta-alumina.

Gamma-alumina can be a preferred choice for catalytic applications because of a defect spinel crystal lattice that imparts to it a structure that is both open and capable of high surface area. Gamma alumina has a face-centered cubic close-packed oxygen sub-lattice structure having a high surface area typically of 150-300 m²/g, a large number of pores with diameters of 30-120 angstroms and a pore volume of 0.5 to >1 cm³/g. Moreover, the defect spinel structure has vacant cation sites giving the gamma-alumina some unique properties.

High surface area alumina materials, also referred to as “gamma alumina” or “activated alumina,” used with TWC catalysts typically exhibit a BET surface area in excess of 60 m²/g, and often up to about 200 m²/g or more. Such activated alumina can be a mixture of the gamma and delta phases of alumina, but may also contain substantial amounts of eta, kappa, and theta alumina phases. Refractory metal oxides other than activated alumina may be utilized as a support for at least some of the catalytic components in a given catalyst. For example, bulk ceria, zirconia, alpha-alumina and other materials are known for such use. Although many of these materials have a lower BET (Brunauer, Emmett, and Teller) surface area than activated alumina, that disadvantage tends to be offset by the greater durability of the resulting catalyst.

It is known that the efficiency of supported catalyst systems is often related to the surface area on the support. This can be true for systems using precious metal catalysts or other expensive catalysts, where the number of active sites plays a role in catalyst efficiency. The greater the surface area, the more catalytic material that is exposed to the reactants, thus less time and less catalytic material is needed to maintain a high rate of productivity.

Heating gamma-alumina may result in a slow and continuous loss of surface area, and a slow conversion to other polymorphs of alumina having much lower surface areas. Thus, when gamma-alumina is heated to high temperatures, the structure of the atoms collapses such that the surface area decreases substantially. Higher temperature treatment above 1100° C. ultimately provides alpha-alumina, a denser, harder oxide of aluminum often used in abrasives and refractories. While alpha-alumina is the most stable of the aluminas at high temperatures, it also has the lowest surface area.

Exhaust gas temperatures can reach 1000° C. in a moving vehicle. The prolonged exposure of activated alumina, or other support material, to high temperature, such as 1000° C., combined with oxygen and sometimes steam, can result in catalyst deactivation by support sintering. The catalytic metal becomes sintered on the shrunken support medium with a loss of exposed catalyst surface area and a corresponding decrease in catalytic activity. The sintering of alumina has been widely reported in the literature (see, e.g., Thevenin et al., Applied Catalysis A: General, 2001, 212: 189-197). The phase transformation of alumina due to an increase in operating temperature is usually accompanied by a sharp decrease in surface area.

In order to prevent this deactivation phenomenon, various attempts have been made to stabilize the alumina support against thermal deactivation (see Beguin et al., Journal of Catalysis, 1991, 127: 595-604; Chen et al., Applied Catalysis A: General, 2001, 205: 159-172). Adding a stabilizing metal, such as lanthanum, to alumina, a process also known as metal-doping, can stabilize the alumina structure. See, for instance, U.S. Pat. Nos. 4,171,288; 5,837,634; and 6,255,358. In general, the prior art has focused on the stabilization of alumina, mainly gamma-alumina, by using a small amount of lanthana (La₂O₃), typically below 10%, and in most practices between 1-6 wt. %. See, for instance, Subramanian et al. (1991) “Characterization of lanthana/alumina composite oxides,” Journal of Molecular Catalysis, 69: 235-245. For most of the lanthana-doped alumina compositions, the lanthanum is in the form of lanthanum oxide. See, for instance, Bettman et al., (1989) “Dispersion Studies on the System La₂O₃/Y—Al₂O₃,” Journal of Catalysis, 117: 447-454.

As discussed above, previous alumina-supported catalysts often do not provide either the thermal stability, or enough active sites to serve as effective catalysts. Doping with a stabilizer material can improve thermal stability; however mere admixtures or mechanical blends with these added materials often do not yield optimal results. Additionally, known supports used in catalysts containing precious metals often suffer from a decrease in available active sites after high-temperature aging.

The present disclosure addresses the problems in the art of thermally stable catalyst supports.

### SUMMARY

The following embodiments meet and address these needs. The following summary is not an extensive overview. It is intended to neither identify key or critical elements of the various embodiments, not delineate the scope of them.

Provided is a catalyst carrier comprising a porous support and a barium sulfate layer dispersed on outer and inner surfaces of the porous support and chemically bonded thereto, wherein the catalyst carrier has a BET surface area of at least about 100 m²/g, and an average pore radius of about 80 Angstroms to about 150 Angstroms. In an embodiment, the porous support is alumina. The alumina can be selected from the group consisting of boehmite, gamma-alumina, delta-alumina, theta-alumina, and combinations thereof.

In an embodiment, the barium sulfate layer comprises barium sulfate in an amount of about 0.5% by weight to about 10% by weight. In an embodiment, the barium sulfate layer comprises barium sulfate in an amount of about 3.5% by weight to about 5% by weight.

The catalyst carrier optionally further comprises a precious metal selected from the group consisting of platinum, palladium, rhodium, ruthenium, osmium, iridium, and combinations thereof. In an embodiment, the catalyst carrier comprising a precious metal contains about 40% more precious metal active sites relative to the same porous support absent the barium sulfate layer.

Also provided is an emissions treatment system for an exhaust gaseous stream comprising a catalyst carrier comprising a porous support and a barium sulfate layer dispersed on outer and inner surfaces of the porous support and chemically bonded thereto, wherein the catalyst carrier has a BET surface area of at least about 100 m²/g, and an average pore radius of about 80 Angstroms to about 150 Angstroms. The catalyst carrier can be disposed on a ceramic or metallic honeycomb flow-through substrate in the emissions treatment system.

A method for preparing a catalyst carrier is also provided. The method comprises the steps of a) providing a porous support comprising alumina (Al₂O₃) impregnated with barium oxide and/or barium carbonate; b) treating the porous support with at least one molar equivalent of sulfuric acid based on barium oxide and/or barium carbonate, to produce a porous support having a barium sulfate layer dispersed on outer and inner surfaces of the porous support; and c) optionally drying the porous support having the barium sulfate layer, thereby forming the catalyst carrier. In an embodiment, the catalyst carrier prepared has a BET surface area of at least about 100 m²/g, and an average pore radius of about 80 Angstroms to about 150 Angstroms.

In an embodiment of the process, the sulfuric acid is from about 1 molar equivalent to about 2 molar equivalents based on barium oxide and/or barium carbonate is step b). In an embodiment, step a) is carried out at a temperature between about 500° C. and about 750° C.

Optionally, the process for preparing a catalyst carrier further comprises the steps of d) impregnating the catalyst carrier with an aqueous precious metal salt solution to form an impregnated catalyst carrier; and e) drying the impregnated catalyst carrier to provide a precious metal-containing catalyst carrier. In an embodiment, the process excludes the step of drying the porous support having the barium sulfate layer prior to step d). The aqueous precious metal salt solution can comprise a precious metal selected from the group consisting of platinum, palladium, rhodium, ruthenium, osmium, iridium, and combinations thereof.

### BRIEF DESCRIPTION OF THE DRAWINGS

FIG. 1 depicts an XRD pattern of a large pore gamma alumina starting material used in Example 1, illustrating the presence of gamma- and delta-alumina phases.

FIG. 2 depicts an XRD pattern of a large pore gamma alumina starting material used in Example 1, calcined in air at 1100° C. for 3 hours illustrating formation of delta- and theta-alumina phases, and also alpha-alumina. Arrows point to some exemplary alpha-alumina peaks present in the aged starting material.

FIG. 3 depicts an XRD pattern of a catalyst carrier comprising BaSO₄ including a precious metal, prepared as described in Example 1, having the composition 4% Pd/5% BaSO₄/Thermally Stable Alumina.

FIG. 4 depicts an XRD pattern of a catalyst carrier comprising BaSO₄ including a precious metal, prepared as described in Example 1, having the composition 4% Pd/5% BaSO₄/Thermally Stable Alumina and calcined in air at 1100° C. for 3 hours.

FIG. 5 depicts an XRD pattern of a catalyst carrier comprising BaSO₄ including a precious metal, prepared by mechanical fusion (MF) as described in Example 2, having the composition 4% Pd/5% BaSO₄/Alumina-MF as prepared.

FIG. 6 depicts an XRD pattern of a catalyst carrier comprising BaSO₄ including a precious metal, prepared by mechanical fusion (MF) as in Example 2, having the composition 4% Pd/5% BaSO₄/Alumina-MF and calcined in air at 1100° C. for 3 hours.

FIG. 7 depicts engine data obtained according to standard methods using a multi-layer catalyst prepared with a catalyst carrier of Example 1A (Catalyst 1) or a catalyst carrier of Example 2A (Catalyst 2) in comparison to a multilayer control (Control Catalyst 1). All three multi-layered catalysts had a precious metal load 30 g/ft³; precious metal ratio 0/9/1 Pt/Pd/Rh=27 g/ft³ Pd and 3 g/ft³ Rh.

FIG. 8 depicts CO chemisorption data as measured by infrared spectroscopy comparing Catalyst 1 (a multi-layer catalyst made as in Example 1A using 4% Pd/5% BaSO₄/Thermally Stable Alumina of Example 1; solid line) with Control Catalyst 1, a standard palladium-and rhodium-containing catalyst lacking barium sulfate (dashed line).

FIG. 9 depicts HC emissions data for a Control Catalyst 2, Catalyst 3, Catalyst 4 and Catalyst 5. Catalysts were engine aged 80 hours at 1070° C. Control Catalyst 2 comprises Pd supported on alumina. Catalyst 3 comprises Pd impregnated on BaO/alumina and thermally fixed prior to washcoating onto the substrate. Catalyst 4 and Catalyst 5 comprise Pd supported on 5% BaSO₄/Thermally stable Alumina catalyst carrier. The Pd-catalyst carrier was thermally fixed prior to washcoating onto the substrate for Catalyst 5 but not Catalyst 4.

FIG. 10 depicts HC emissions data for catalysts as a function of BaSO₄ weight percent. Catalysts were engine aged 80 hours at 1070° C. Control Catalyst 3 comprises no BaSO₄/Thermally stable Alumina catalyst carrier. Catalysts 6, 7, and 8 comprise 5% BaSO₄/Thermally stable Alumina catalyst carrier, 7.5% BaSO₄/Thermally stable Alumina catalyst carrier, and 10% BaSO₄/Thermally stable Alumina catalyst carrier respectively.

FIG. 11 depicts XRD patterns of a Sample 3 (4% Pd/3.5% BaSO₄/Thermally Stable Alumina) before (“as prepared”) and after aging (“aged”) by calcination in air at 1100° C. for 3 hours.

FIGS. 12A and 12B are schematics of exemplary embodiments of an emission treatment system. FIG. 12A depicts an emission system 1 comprising a single canister 4. A close-coupled catalyst substrate 5 and a downstream catalyst substrate 7 are contained within the canister 3. The engine 9 is located upstream of the emission system 1. FIG. 12B depicts an emission system 11 comprising a first canister 13 which comprises a close-coupled catalyst substrate 15 and a second canister 17 which comprises a downstream catalyst substrate 19. The engine 21 is located upstream of the emission system 11. Arrows indicate the flow of exhaust from the engine to the emissions system and to the environment or optional additional treatment system.

FIG. 13 is a bar graph depicting the engine emissions performance of Catalyst 9 relative to Catalyst 10 under two different testing protocols: FTP75 and US06. Positive percent reflects improved emissions reduction of Catalyst 9 relative to Catalyst 10. THC=total hydrocarbon. NMHC=non-methane hydrocarbon. CO=carbon monoxide. NOx=nitrogen oxides.

### DETAILED DESCRIPTION

Treatment of catalyst support materials such as alumina with aqueous barium salts is well-known. For example, impregnation of gamma alumina with aqueous barium acetate, followed by drying and calcining yields a BaO/alumina supported materials. However, as demonstrated herein, further treatment of barium oxide or complex mixed oxides containing barium, on a support, with sulfuric acid, gives BaSO₄/alumina materials that are unexpected thermally stable and provide advantageous characteristics as catalyst carriers for formation of emissions catalysts.

Accordingly, a catalyst carrier having improved thermal stability is provided, as well as a method of making the catalyst carrier and methods of using it. As used herein, “improved thermal stability” refers to substantially reduced or substantially eliminated formation of alpha-alumina, as detected by, for instance, XRD, after an aging protocol as described elsewhere herein, relative to a porous support absent the barium sulfate and subjected to aging by the same protocol. The BaSO₄ catalyst carrier further exhibits increased stability in aqueous slurries at pH ranging from 2-10, relative to BaO— and BaCO₃-containing alumina. BaO— and BaCO₃-containing alumina are reactive in acidic conditions, which causes the Ba to become soluble. Since barium is both a stabilizer and a PGM promoter, loss of barium reduces the efficacy of a catalyst carrier carrying a PGM. Without wishing to be bound by theory, it is believed that the barium in BaSO₄ is resistant to solubilization in acidic conditions, thereby minimizing or precluding the loss of barium in acidic conditions and preserving the barium for function as a stabilizer and a PGM promoter in emissions abatement.

The catalyst carrier comprises a porous support and a layer of barium sulfate. The layer of barium sulfate is dispersed on outer and inner surfaces of the porous support. Optionally, the catalyst carrier further comprises a precious metal. Advantageously, the catalyst carrier can contain about 40% more precious metal active sites, relative to the same porous support in the absence of barium sulfate.

The amount of barium sulfate deposited on the porous support material ranges from greater than 0% to about 20% by weight. In one embodiment, the barium sulfate is present an amount ranging from 0.5% to 10%, 1% to less than 10%, 2.5% to 7.5%, 3% to 7%, or 3% to 5% by weight. In an embodiment, the barium sulfate is present at about 3.5% by weight. In another embodiment, the barium sulfate is present at about 5% by weight. In an embodiment, the catalyst carrier comprises a barium sulfate layer on a large pore alumina, wherein the barium sulfate ranges from 3.5% weight to about 5% by weight. In an embodiment, the catalyst carrier comprises a barium sulfate layer on a large pore alumina, wherein the barium sulfate comprises about 3.5% weight.

Barium sulfate can be prepared on the porous support by any method known that results in a barium sulfate layer that thermally stabilizes the porous support. The barium sulfate layer of the catalyst carrier described herein is generally evenly and well-dispersed on the outer surfaces and inner surfaces of the porous support. The barium sulfate layer of the catalyst carrier is generally bonded on the outer surfaces and within inner surfaces of the porous support, which can include the pores of the porous support. Without intending to be bound by theory, the nature of the bonding can be covalent or ionic. Although bonding types vary, it is generally understood that bonding, and chemical bond strengths, can range from ionic to covalent within a molecular framework. As such, the catalyst carrier described herein comprises barium sulfate bonded chemically or mechanically to the porous support, and is not merely an admixture of separate or distinct materials. Exemplary porous support materials include large pore alumina, for example having an average pore radius greater than about 80 Angstroms, for example about 80 to about 150 Angstroms, and total pore volume greater than about 0.75 cm³/g. For example, commercially available gamma-alumina can have a pore volume of about 0.5 to >1 cm³/g. It is generally understood that the pores of the alumina define an inner surface (i.e. inner surfaces of the pores), as well as a total pore volume. In an embodiment, therefore, barium sulfate can be deposited and/or dispersed on outer surfaces and within inner surfaces of an alumina material to provide a novel catalyst carrier. Other exemplary porous support materials include, but are not limited to, zirconium oxide, solid solution Ce/Zr, Ce/Zr-aluminates and zeolitic supports.

Exemplary aluminas include large pore boehmite, gamma-alumina, and delta/theta alumina. Useful commercial aluminas used as starting materials in exemplary processes include activated aluminas, such as high bulk density gamma-alumina, low or medium bulk density large pore gamma-alumina, and low bulk density large pore boehmite, available from BASF Catalysts LLC (Port Allen, La., USA) and Sasol Germany GmbH (Hamburg, Germany). BaO-doped alumina can also be obtained from BASF Catalysts LLC (Port Allen, La., USA) and Sasol Germany GmbH (Hamburg, Germany).

In an embodiment, barium sulfate is prepared chemically in situ on the porous support such as alumina by treatment of barium oxide (BaO) and/or barium carbonate (BaCO₃) with sulfuric acid (H₂SO₄). The barium sulfate layer formed by in situ by treatment of barium oxide and/or barium carbonate with sulfuric acid is chemically bonded to the porous support such as alumina. The barium sulfate formed in situ is generally evenly dispersed on the outer surfaces and within inner surfaces of the porous support. The catalyst carrier including a barium sulfate layer thus chemically formed retains a porous structure, and the barium sulfate layer may not be necessarily continuous throughout the surfaces, but is generally well-dispersed. As demonstrated herein, a catalyst carrier prepared by chemical in situ formation of barium sulfate exhibits improved thermal stability.

In an exemplary process for in situ formation, the starting porous support material can be impregnated with a barium salt solution, such as barium acetate or barium carbonate, or a mixture comprising a barium salt solution to a minimum of about 80% incipient wetness, in order to prepare a BaO and/or BaCO₃ porous support. Impregnation of the starting material can be carried by feeding the dried, powdered materials from a drum or bag, and the wet materials as salt solutions to charge a mixer, such as that supplied by a Littleford Mixer available from Littleford Day, Inc., Florence, Ky. Mixing can be conducted for a time sufficient so that a fine uniform mix results. The wet materials (i.e., barium salt solution) can be delivered to the mixer, for instance, via peristaltic pump with a maximum volume flow rate of about 2 L/min via a nozzle producing a conical atomized spray for impregnation/dispersion of the solution onto the porous support material. After stirring to achieve a minimum of about 80% incipient wetness, the impregnated support material can be optionally dried and calcined, to produce a BaO and/or BaCO₃ porous support. Optionally, the impregnated support material can be de-lumped, screened, and/or sized before drying/calcination. Calcination can be carried out using a flash calciner, a tray and batch furnace, box oven, or a rotary kiln. In an embodiment, calcination can be carried out using a rotary kiln or a flash calciner. Exemplary temperatures for calcination include from about 400° C. to 750° C. and 400° C. to 600° C. Exemplary durations of calcination include from about 1 second to 2 hours. Generally, spray-drying techniques are excluded, such as using a flash vessel in which hot gases downwardly descend in a helical trajectory and converge into a vortex, for flash drying of droplets, as described in U.S. Pat. No. 5,883,037.

As demonstrated herein, thermally stable BaSO₄/Alumina can be prepared without requiring a calcination step of barium acetate-impregnated material prior to treatment with sulfuric acid. Therefore, in an embodiment, the preparation of the BaO and/or BaCO₃ porous support via the in situ process excludes a step of drying and calcining prior to treatment with sulfuric acid to form BaSO₄.

The BaO and/or BaCO₃ porous support is then treated in situ with at least one molar equivalent of sulfuric acid. Sulfuric acid can be provided in a range up to about 2.0 equivalents, based on barium salt. In an embodiment, sulfuric acid is added in an amount ranging from about 1.5 to 1.9 equivalents, based on barium salt. In an embodiment, sulfuric acid is added in an amount of about 1.7 equivalents, based on barium salt. Alternatively, an excess of sulfuric acid can be used to ensure complete stoichiometric formation of BaSO₄ from BaO. In this manner, efficient use of the reagent is employed, while pH in the product is controlled. After treatment with sulfuric acid, the material can be optionally dried and/or calcined at a sufficient temperature and time to remove substantially all free moisture/water and any volatiles formed during the reaction of sulfuric acid and barium acetate. Without wishing to be bound by theory, it is believed calcination can also decompose residual unreacted barium acetate or barium carbonate.

In an embodiment, the porous support is a large pore alumina. Thus, BaSO₄ is made via direct acid/base reaction of BaO and/or BaCO₃ dispersed on a large pore alumina, such as gamma alumina.

In an embodiment, excess sulfuric acid is used and consumed via reaction with the alumina to form aluminum sulfate, Al₂(SO₄)₃, the excess being employed to ensure 100% formation of BaSO₄. It should be noted that the by-product aluminum sulfate can potentially act as exchange sites (acidic sites) producing an acidic, low pH support, where BaO/BaCO₃-alumina is basic, high pH. This surface chemistry may be important when coupled with one or more platinum group metals (PGM), for example palladium nitrate, processed to thermally fix the precious metal by calcination.

The salt solutions used in preparing the catalyst carrier by in situ chemical formation can be nitrate or acetate solutions. The salts are generally soluble, such that homogeneous salt solutions are employed in the process. Other appropriate aqueous acidic salt solution can be used. The pH of the acidic solution can range from about 1 to about 5.

In another embodiment, barium sulfate is prepared by mechanical fusion. Commonly-assigned U.S. Pub. No. 20100189615 describes mechanically-fused components. Mechanical fusion involves host and guest particles, i.e., BaSO₄ is the guest particle which is fused to the porous support such as alumina via mechanical forces. The mechanofusion-based catalyst carrier is a core and shell arrangement, wherein the porous support is the core and the BaSO₄ is the shell. This arrangement is sufficient for enabling the BaSO₄ to be in close proximity to the PGM for optimal promoter effect. The thermal stability of the catalyst carrier prepared by mechanical fusion is not as pronounced as that for the catalyst carrier prepared by in situ chemical formation. However, as demonstrated herein, both methods of production result in catalyst carriers having improved emissions abatement in catalysts, such as TWC catalysts.

Precious metals, such as platinum group metals (PGM), can be optionally used to make catalytic compositions comprising the BaSO₄/porous support catalyst carrier. Platinum group metals include platinum, palladium, rhodium, ruthenium, osmium, and iridium. Combinations of platinum group metals is also possible. Suitable concentrations are well known in the art. For instance, precious metal in the range of about 0.1 wt. % to about 15 wt. % is useful in emissions abatement applications. As demonstrated herein, reduction of hydrocarbon emissions is improved if the PGM is thermally fixed to the catalyst carrier prior to dispersing the material on a substrate, such as a monolith, via washcoating. In an embodiment, the catalyst carrier comprises a barium sulfate layer on a large pore alumina, wherein the barium sulfate ranges from 3.5% weight to about 5% by weight and further comprises a PGM such as palladium. In an embodiment, the catalyst carrier comprises a barium sulfate layer on a large pore alumina, wherein the barium sulfate is about 3.5% weight, and the carrier further comprises palladium. In an embodiment, the 3.5 wt % BaSO₄/thermally stable alumina catalyst carrier is prepared by the is situ process described elsewhere herein.

Accordingly, the BaSO₄/porous support catalyst carrier described herein optionally can be further treated with precious metal salts to deposit precious metal on the dried/calcined support material. In an exemplary process, the catalyst carrier can be impregnated with a precious metal salt solution, and the resulting impregnated catalyst carrier can then be calcined. For instance, the calcined catalyst carrier prepared by in situ chemical formation of barium sulfate, or the catalyst carrier prepared by mechanical fusion can be impregnated with a precious metal salt solution and then calcined. In an alternative process of the in situ chemical formation process, precious metal salts can be added prior to the drying/calcination step. Thus, a combination of a base metal salt such as barium acetate or barium carbonate and one or more precious metal salts in one impregnation step followed by a calcination step is also contemplated. Useful precious metal salts include palladium(II) nitrate and the like.

Tables 1 and 2 summarize material properties of exemplary commercial starting materials in comparison to exemplary catalyst carrier according to this disclosure.

TABLE 1

| | | | | | | Pore |
|---|---|---|---|---|---|---|
| | | | | | Pore | Distribution |
| | Alumina | BET | | | Distribution | (cm³/g) - |
| | Material | surface | Ave. Pore | Total | (cm³/g) - | Between |
| | Description | area | Radius | Pore Vol. | micro-pore | 10.000 Å |
| Sample | (Preparation) | (m²/g) | (angstrom) | (cm³/g) | volume | and 300.000 Å |
| S.M. 1 | Large Pore | 118.59 | 87.27 Å | 0.70550 | 0.00338 | 0.68175 |
| | Gamma | | | | | |
| S.M. 1 | Large Pore | 78.09 | 109.48 Å | 0.58017 | 0.00254 | 0.56005 |
| aged¹ | Gamma | | | | | |
| 1 | 4% Pd/ | 109.88 | 87.77 Å | 0.61177 | 0.00264 | 0.58603 |
| | 5% BaSO₄/ | | | | | |
| | Alumina | | | | | |
| | (in situ) | | | | | |
| 1 aged¹ | 4% Pd/ | 77.70 | 117.35 Å | 0.56638 | 0.00335 | 0.56127 |
| | 5% BaSO₄/ | | | | | |
| | Alumina | | | | | |
| | (in situ) | | | | | |
| 2 | 4% Pd/ | 110.32 | 76.27 Å | 0.48067 | 0.00176 | 0.48047 |
| | 5% BaSO₄/ | | | | | |
| | Alumina | | | | | |
| | (mechano- | | | | | |
| | fusion | | | | | |
| | comparator) | | | | | |
| 2 aged¹ | 4% Pd/ | 70.12 | 108.14 Å | 0.44090 | 0.00291 | 0.44246 |
| | 5% BaSO₄/ | | | | | |
| | Alumina | | | | | |
| | (mechano- | | | | | |
| | fusion | | | | | |
| | comparator) | | | | | |

S.M. = Starting Material 1
¹Calcined in box oven at 1100° C./3 hr in air

TABLE 2

| | | | | | | Pore |
|---|---|---|---|---|---|---|
| | | | | | Pore | Distribution |
| | Alumina | BET | | | Distribution | (cm³/g) - |
| | Material | surface | Ave. Pore | Total | (cm³/g) - | Between |
| | Description | area | Radius | Pore Vol. | micro-pore | 10.000 Å |
| Sample | (Preparation) | (m²/g) | (angstrom) | (cm³/g) | volume | and 300.000 Å |
| S.M. 2 | Large Pore | 129.31 | 97.624 Å | 0.83624 | 0.00207 | 0.75961 |
| | Gamma | | | | | |
| S.M. 2 | Large Pore | 90.35 | 116.942 Å | 0.72353 | 0.00164 | 0.64381 |
| aged¹ | Gamma | | | | | |
| 3 | 4% Pd/ | 124.92 | 96.557 Å | 0.75690 | 0.00364 | 0.69359 |
| | 3.5% BaSO₄/ | | | | | |
| | Alumina | | | | | |
| | (in situ; | | | | | |
| | single | | | | | |
| | calcination²) | | | | | |
| 3 aged¹ | 4% Pd/ | 81.46 | 121.243 Å | 0.69018 | 0.00196 | 0.61251 |
| | 3.5% BaSO₄/ | | | | | |
| | Alumina | | | | | |
| | (in situ; | | | | | |
| | single | | | | | |
| | calcination²) | | | | | |

S.M. 2 = Starting Material 2
¹Calcined in box oven at 1100° C./4 hr in air
²Single calcination step in preparing BaSO₄/Alumina catalyst carrier

Starting Materials 1 and 2 are two commercially-available large-pore alumina. As shown in Tables 1 and 2, micro-pore volume in Starting Materials 1 and 2 before and after aging remains low. Use of an alumina having low micropore volume contributes to minimizing platinum group metals (PGM) loss due to encapsulation when micropores collapse.

As shown in Table 1, Example 1, an exemplary carrier catalyst prepared by in situ chemical formation of barium sulfate and comprising a PGM, is comparable to the starting material in surface area and average pore radius. Example 2, prepared by mechanical fusion, also has comparable average pore radius and surface area, compared to the starting material. As shown in Table 2, Example 3, an exemplary carrier catalyst prepared by in situ chemical formation of barium sulfate, comprising a PGM and using a single calcination step in preparing the BaSO₄/Alumina catalyst carrier, is also comparable to the starting material in surface area and average pore radius.

### Methods of Use

The catalyst carrier prepared as described herein can be used in the preparation of exhaust gas purification catalysts useful in emission treatment or control systems. An exhaust gas purification catalyst composition can comprise the catalyst carrier, optionally supporting a PGM, in admixture with other optional ingredients, such as a surfactant, an oxygen storage component, and the like. The catalyst composition can be deposited onto one or more substrates using any method known in the art. Exemplary substrates include, but are not limited to, a ceramic or metallic honey flow-through substrate or monolith. Exemplary methods for depositing the catalyst composition on the substrate include: washcoating, imbibing, impregnating, physisorbing, chemisorbing, precipitating, and combinations comprising at least one of the foregoing deposition methods. The term “washcoat” as used herein describes the layer or layers of, for instance, a catalytically active admixture composition deposited on a substrate. A substrate may be sequentially washcoated with different materials, thereby forming multi-layered catalyst substrates.

The resulting substrate comprising the catalyst carrier and other components of the catalyst composition can be part of an emissions treatment system used, for instance, to treat and/or purify gaseous products discharged from an internal combustion engine. For instance, as demonstrated herein, TWC multi-layer catalyst comprising a catalyst carrier of the disclosure exhibits improved emissions control, regarding abatement of carbon monoxide, hydrocarbons, and NOₓ emissions. Without wishing to be bound by theory, the improvement is believed to result at least in part to improved thermal stability of the BaSO₄/porous support catalyst carrier.

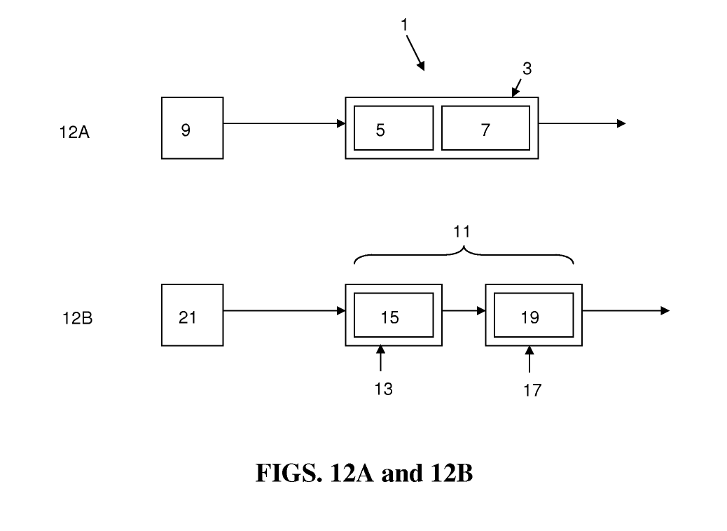

An exemplary emissions treatment system for treating an exhaust gaseous stream, such as from an internal combustion engine, can include a close-coupled catalyst substrate (i.e., positioned in close proximity to the engine) and a second catalyst substrate positioned further downstream from the engine than the close-coupled substrate (e.g., an under-floor catalyst substrate). Exemplary embodiments are depicted in FIGS. 12A and 12B. FIG. 12A depicts an emission system 1 comprising a single canister 3. A close-coupled catalyst substrate 5 and a downstream catalyst substrate 7 are contained within the canister 4. An engine 9 is located upstream of the emission system 1. FIG. 12B depicts an emission system 11 comprising a first canister 13 which comprises a close-coupled catalyst substrate 15 and a second canister 17 which comprises a downstream catalyst substrate 19. The engine 21 is located upstream of the emission system 11. The use of the catalyst carrier of the present disclosure is contemplated as being particularly advantageous in the close-coupled catalyst. Other configurations of emission treatment systems and other uses of the catalyst carrier will be readily apparent to the skilled artisan.

### EXAMPLES

It should be understood that the illustrated embodiments are exemplary only, and should not be taken as limiting the scope of the materials, compositions, and methods discussed.

### Example 1

### Preparation of 4% Pd/5% BaSO₄/Thermally Stable Alumina Using Sulfuric Acid

The following example describes the preparation of catalyst carrier material that was prepared using two drying/calcining steps.

Step 1. Preparation of 3.35% BaO/Alumina.

Large pore gamma alumina (98%, balance water) (223.87 kg) was treated with the following aqueous pre-mix, where the salt is expressed as wt % in water: 24% barium acetate (31.68 kg), diluted with water to achieve ca. 90% incipient wetness point, and DI water (120.78 kg). Rinse deionized (DI) water (2 kg) was used for transfer to the mixer. Impregnation of the large pore gamma alumina was achieved by mixing for 20 minutes prior to transfer to a plastic drum (of a 60% solids wet preparation), from which the impregnated material was fed to a calciner (600° C.; time sufficient to remove substantially all water), to produce the desired 3.35% BaO/Alumina product.

Step 2. Preparation 5% BaSO₄/Thermally Stable Alumina.

3.35% BaO/Alumina (98%, balance water) (231.63 kg) was treated with ca. 5.8% aq. sulfuric acid solution (8.40 kg, stoichiometric to BaO plus 70% excess) to ca. 90% incipient wetness point, and DI water (136.29 kg). Rinse DI water (2 kg) was used for transfer to the mixer. Impregnation and acid/base reaction to form BaSO₄ was achieved by mixing for 20 minutes to give a 60% solids wet preparation. The impregnated material was then fed to a calciner (600° C., time sufficient to remove substantially all water and volatiles that formed during reaction), to produce the desired 5% BaSO₄/Thermally Stable Alumina product. Product form: powder to fine brown-black granules; pH value slurry in water at 25° C.: 4; bulk density: 600-1,200 kg/m³.

Step 3. 4% Pd/5% BaSO₄/Thermally Stable Alumina.

A precious metal was deposited on the catalyst carrier material of step 2 as follows. 5% BaSO₄/Thermally Stable Alumina (98%, balance water) (66.71 kg) was treated with the following aqueous pre-mix, where salt is expressed as wt % in water: 20.63% palladium nitrate (13.20 kg), to ca. 90% incipient wetness point, and DI water (24.49 kg). Rinse DI water (2 kg) was used for transfer to the mixer. Impregnation was achieved by mixing for 20 min. prior to transfer to a plastic drum (of a 64% solids wet preparation), from which the impregnated material was fed to a calciner (600° C., time sufficient to remove substantially all water) to produce the desired 4% Pd/5% BaSO₄/Thermally Stable Alumina product (Sample 1).

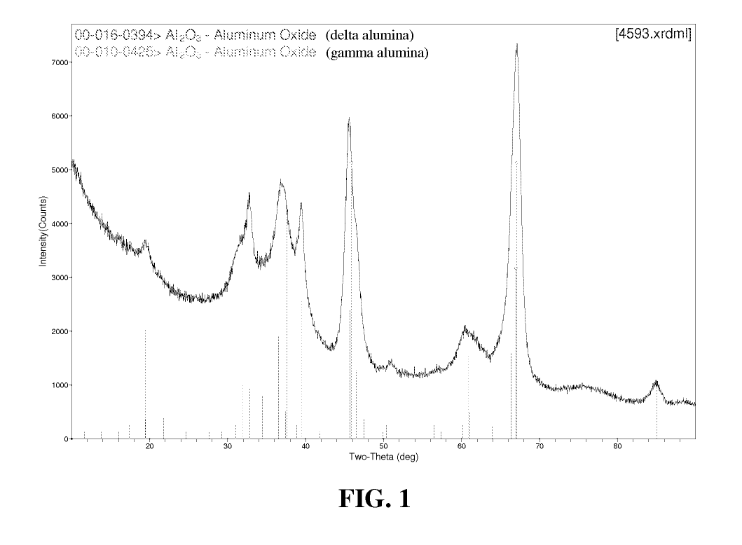

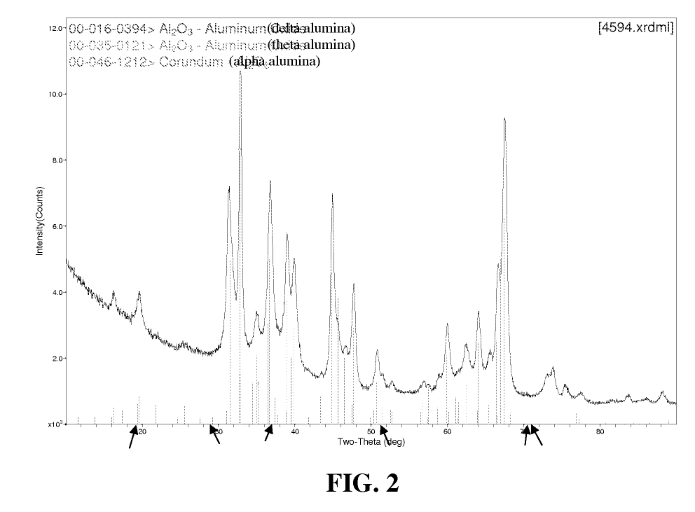

FIG. 1 provides an XRD pattern of large pore gamma alumina starting material. FIG. 2 shows an XRD pattern for the same material aged by calcination in air at 1100° C. for 3 hours. Comparison shows undesirable formation of alpha alumina phase. See Table 3.

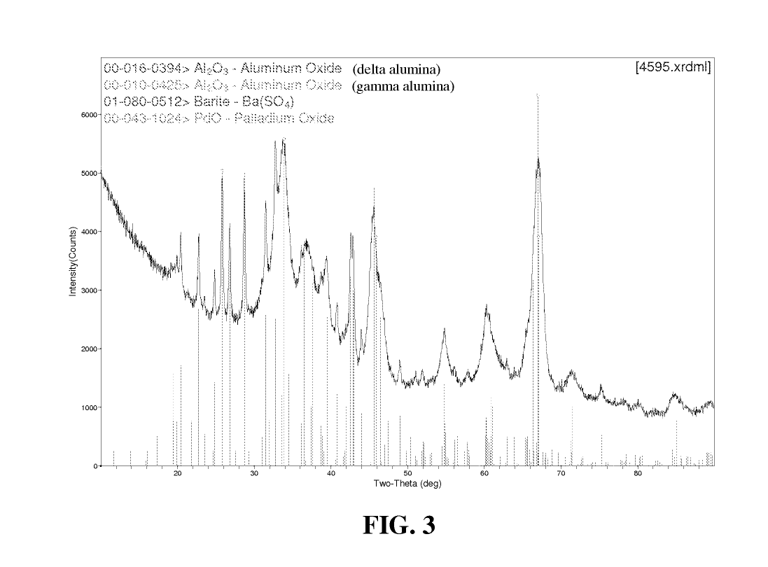

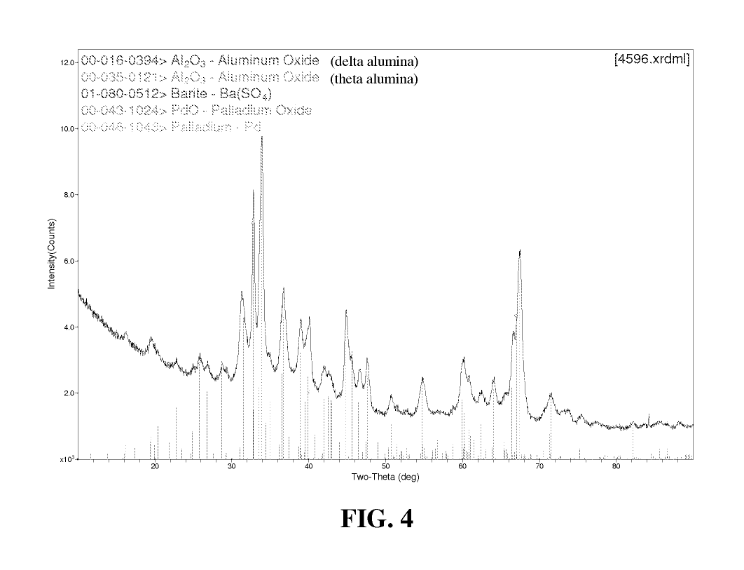

FIG. 3 provides an XRD pattern for 4% Pd/5% BaSO₄/Thermally Stable Alumina (Sample 1) as prepared. FIG. 4 shows an XRD pattern for the same material aged by calcination in air at 1100° C. for 3 hours. The improved thermal stability of the product is shown in Table 3, indicated by formation of delta- and theta-alumina phases, and no alpha-alumina formation post-aging.

TABLE 3

| | | XRD Phases |
|---|---|---|
| | | (Incl. Transition |
| Sample | Sample Treatment | alumina) |
| Starting | Commercial | transition alumina |
| Material | | (gamma, delta) |
| Starting | Calcined in box oven at | transition alumina |
| Material, | 1100° C./3 hr in air | (delta, theta), trace |
| aged | | alpha alumina |
| 1 | Product As-prepared | transition alumina |
| | | (gamma, delta), |
| | | BaSO₄, PdO |
| 1, aged | Calcined in box oven at | transition alumina |
| | 1100° C./3 hr in air | (delta, theta), |
| | | BaSO₄, PdO, trace |
| | | Pd |

### Example 2

### Preparation of 4% Pd/5% BaSO₄/Alumina By Mechanically Fusing (MF) Commercial BaSO₄

5.79 Kg of a large pore gamma alumina and 0.305 Kg bulk barium sulfate (d50=2 microns) was mechanically fused using a Nobilta 300™ reactor obtained from Hosokawa Micron Powder Systems (Summit, N.J.) for 81 minutes to achieve a specific energy of 2.0 (KW-Hr)/Kg to provide 5% BaSO₄/Alumina. Following this, step 3 of Example 1 was generally repeated to provide the desired product 4% Pd/5% BaSO₄/Alumina-MF (Sample 2).

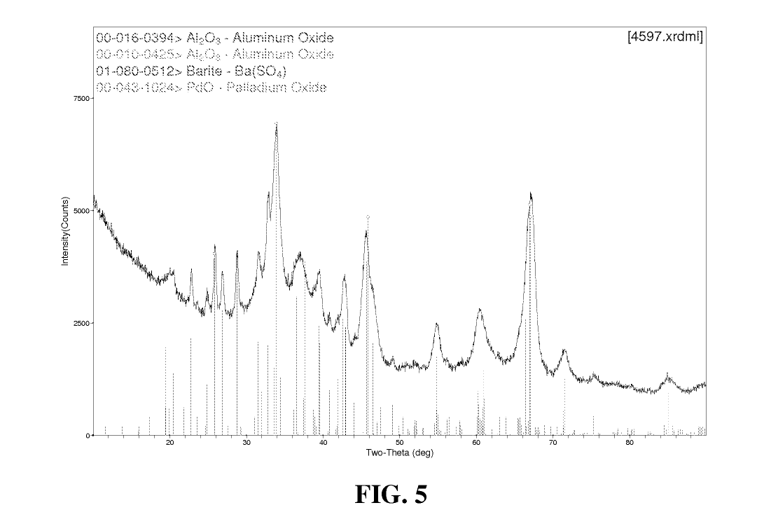

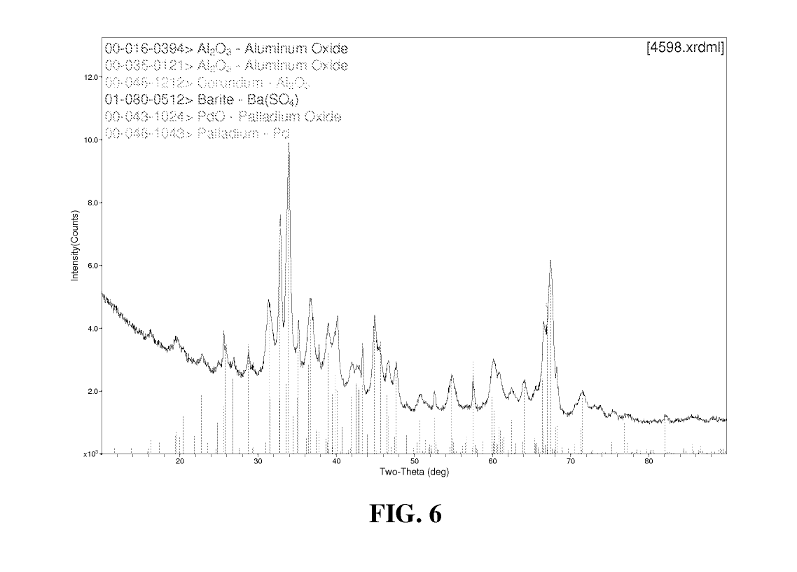

FIG. 5 provides an XRD pattern for 4% Pd/5% BaSO₄/Alumina-MF (Sample 2) as prepared. FIG. 6 shows an XRD pattern for the same material aged by calcination in air at 1100° C. for 3 hours. Formation of delta- and theta-alumina phases was detected. However, this material is not as thermal stable as Sample 1, since alpha-alumina was also observed. See Table 4.

TABLE 4

| | | XRD Phases |
|---|---|---|
| | | (Incl. Transition |
| Sample | Sample Treatment | alumina) |
| 2 | Product As-prepared | transition alumina |
| | | (gamma, delta), |
| | | BaSO₄, PdO |
| 2, aged | Calcined in box oven at | transition alumina |
| | 1100° C./3 hr in air | (delta, theta), |
| | | BaSO₄, PdO, alpha |
| | | alumina, trace Pd |

### Example 5

### Multi-Layer Catalysts Using Catalyst Carrier of Example 1 and Example 2

### 1A: Formation of Catalyst Coating Using Example 1

Catalyst slurry 1A was prepared as follows. To DI water (5.54 kg) in a dispersion tank was added low HLB surfactant (5 g), 24% barium acetate in water (1.45 kg), 45% suspension of Sample 1 in water (2.58 kg), and oxygen storage component (3.56 kg), followed by 20% palladium nitrate in water (20.2 g) as precious metal (i.e., PGM) post-addition dispersion over the slurry. This palladium is in addition to the 4% palladium previously dispersed on the catalyst carrier and is intended to activate the oxygen storage component. The resultant slurry was mixed for 10 minutes, then milled with a wet milling apparatus to particle size d90=8 microns. Rinse DI water (356 g) was used for transfer from the mill to a homogenizer/shear mixer. The resultant slurry was mixed for 10 minutes to fully disperse the components in a 37% solids wet preparation.

### 2A: Formation of Catalyst Coating Using Example 2

Catalyst slurry 2A was prepared as in Example 1A substituting Sample 2 for Sample 1.

Multi-layered catalysts were prepared by washcoating substrates, wherein the middle coat was prepared from either catalyst slurry 1A (Catalyst 1) or catalyst slurry 2A (Catalyst 2). A control multi-layer catalyst (Control Catalyst 1) was prepared wherein the middle coat comprised alumina in place of the barium-sulfate alumina catalyst carrier. The other layers were identical among the three catalysts. All of the multi-layered catalysts so prepared had a precious metal load 30 g/ft³ with a precious metal ratio of 0/9/1 Pt/Pd/Rh (=0 g/ft³ Pt; 27 g/ft³ Pd; and 3 g/ft³ Rh.

Catalysts were aged at 1050° C. for 80 hours according to the V265 European cycle, which is a standard high temperature aging cycle. Engine emissions of the three multi-layered catalysts were then tested using the EU2000 European Test Protocol.

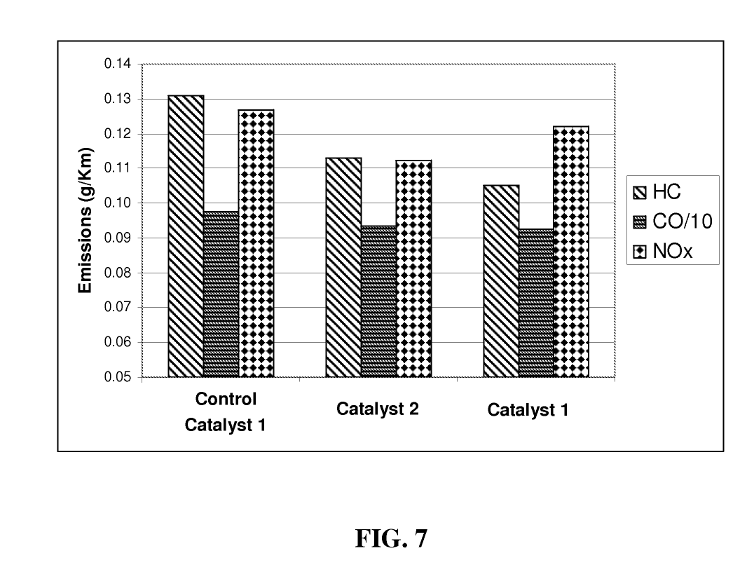

FIG. 7 shows the engine emissions data obtained. Reductions in HC, NOₓ, and CO levels were observed relative to the baseline catalyst (Control Catalyst 1) for both Catalyst 1 and Catalyst 2 indicating improved performance characteristics. Specifically, HC emissions post aging at 1050° C. were reduced relative to control by 14% for Catalyst 2 (comprising Sample 2) and 20% for Catalyst 1 (comprising Sample 1). The improvement in HC emissions, post-aging, is greater for Sample 1, prepared by in situ chemical formation of BaSO₄. Both Catalyst 1 and Catalyst 2 also exhibited a reduction in NOₓ emissions compared to the control. The improvement in NOₓ emissions was greater for Catalyst 2. Reduction of carbon monoxide emissions was also improved for Catalyst 1 and Catalyst 2.

These data suggest that the catalyst carrier, exemplified by Samples 1 and 2, has improved thermal stability compared to alumina alone, leading to improved catalytic activity of the Pd-catalyst carrier post-aging, compared to Control Catalyst 1.

### Example 4

### Comparison of CO Chemisorption/IR Data

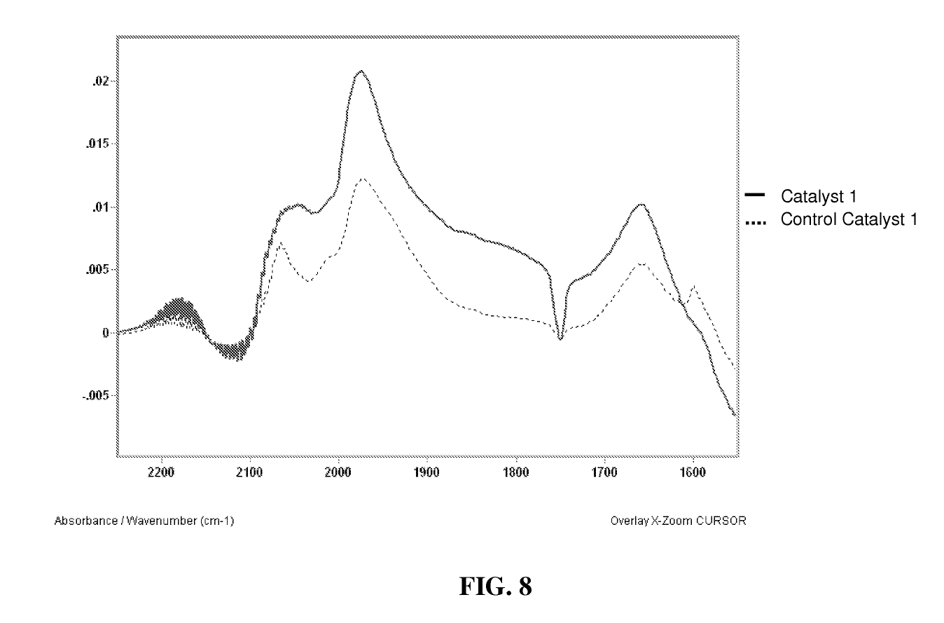

Catalyst 1, post aging at 1050° C., was measured for Pd surface (active sites) using infrared analysis, NO after CO. FIG. 8 depicts CO chemisorption data as measured by infrared spectroscopy comparing Catalyst 1 with Control Catalyst 1. As shown in FIG. 8, the palladium (Pd) absorption of Catalyst 1 was measured at about 40% greater than the Pd absorption of Control Catalyst 1, which has the same palladium concentration on a catalyst support having no BaSO₄. This result indicates 40% more active sites are available using a catalyst made using in situ barium sulfate formation, such as Sample 1.

### Example 5

### Barium Sulfate and Thermal Fixation of PGM

To assess the effect of the type of support and calcination of PGM on engine emissions, four multi-layered catalyst substrates were prepared (see Table 5). Multi-layered catalysts were prepared by washcoating substrates, wherein the middle coat was prepared using the catalyst carrier in Table 5. The other layers were identical among the catalysts. All of the multi-layered catalysts so prepared had a precious metal load of 30 g/ft³ with a precious metal ratio of 0/9/1 Pt/Pd/Rh (=0 g/ft³ Pt; 27 g/ft³ Pd; and 3 g/ft³ Rh. The middle layer of the reference catalyst substrate, Control Catalyst 2, was prepared as follows. Pd was impregnated on an alumina support to 4%. The supported catalyst was then slurried with surfactant, barium acetate and oxygen storage component, then 20% palladium nitrate as post-addition dispersion over the slurry as described in Example 3 and washcoated onto a monolith that comprised a first layer, which was subsequently calcined. The third layer was then applied and the coated monolith was calcined.

The middle layer of Catalyst 3 was prepared as follows. Pd was impregnated on a BaO/alumina catalyst carrier to 4% and calcined to thermally fix the Pd. The thermally-fixed Pd—BaO/alumina material was then slurried with surfactant, barium acetate and oxygen storage component, then 20% palladium nitrate as post-addition dispersion over the slurry as described in Example 3 and washcoated onto a monolith that comprised a first layer, which was subsequently calcined. The third layer was then applied and the coated monolith was calcined.

Catalyst 4 was prepared the same as the reference catalyst, with the difference that the 4% Pd was impregnated on 5% BaSO₄/Thermally stable Alumina catalyst carrier, prepared by in situ chemical formation of BaSO₄. Like the reference catalyst (Control Catalyst 2), the Pd-catalyst carrier material was then slurried with surfactant, barium acetate and oxygen storage component, then 20% palladium nitrate as post-addition dispersion over the slurry as described in Example 3 and washcoated onto a monolith that comprised a first layer, which was subsequently calcined. The third layer was then applied and the coated monolith was calcined.

The middle layer of Catalyst 5 was prepared as described for Catalyst 3, with the difference that the 4% Pd was impregnated on 5% BaSO₄/Thermally stable Alumina catalyst carrier. The Pd-impregnated catalyst carrier was then thermally fixed by calcination, and the material then slurried with surfactant, barium acetate and oxygen storage component, then 20% palladium nitrate as post-addition dispersion over the slurry as described in Example 3 and washcoated onto a monolith that comprised a first layer. The monolith was then calcined. The third layer was then applied and the coated monolith was calcined.

TABLE 5

| Catalyst | Catalyst carrier | Pd thermally fixed? |
|---|---|---|
| Control catalyst 2 | Alumina | No |
| Catalyst 3 | BaO/alumina | Yes |
| Catalyst 4 | BaSO₄/Thermally stable | No |
| | Alumina | |
| Catalyst 5 | BaSO₄/Thermally stable | Yes |
| | Alumina | |

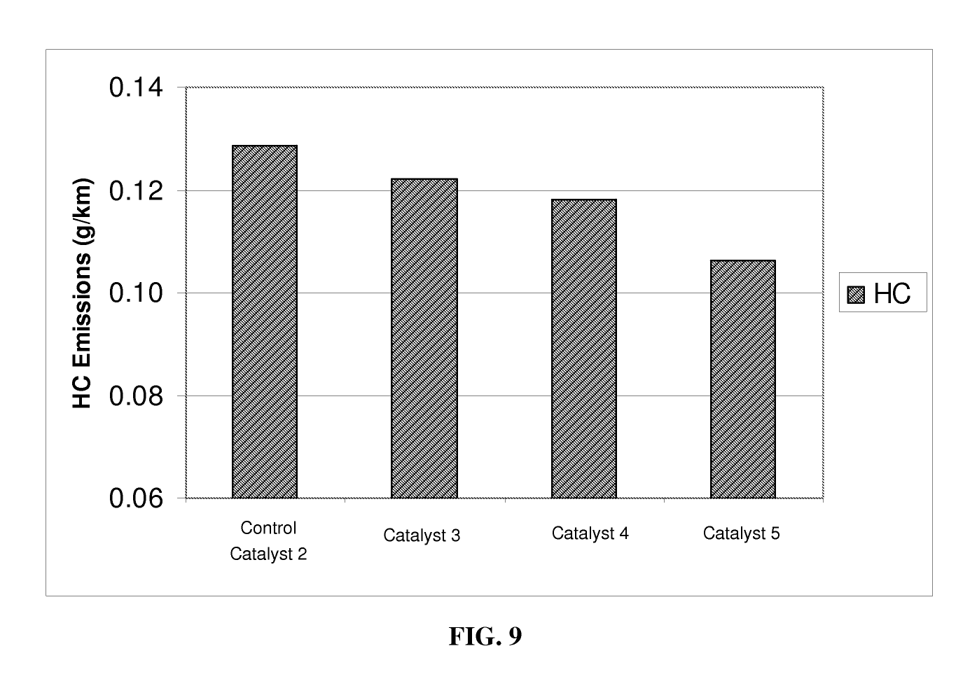

HC emissions were assessed post engine-aging at 1050° C. for 80 hours using the V265 European cycle. The data are depicted in FIG. 9. A comparison of Catalysts 4 and 5 to Control Catalyst 2 and Catalyst 3 demonstrates that improved HC emissions are obtained when precious metal is supported on BaSO₄/Thermally stable Alumina catalyst carrier. A comparison of Catalyst 4 to Catalyst 5 demonstrates that thermally fixing the precious metal to BaSO₄/Thermally stable Alumina catalyst carrier prior to slurrying and washcoating onto a substrate also contributes to improved HC emissions. Therefore, these data show that use of BaSO₄/Thermally stable Alumina as a catalyst carrier, and thermal fixation of the PGM on the catalyst carrier each contribute to improved HC emissions post-aging.

### Example 6

### Barium Sulfate Loading

The effect of the amount of barium sulfate on HC emissions was examined for four multilayer catalyst substrates were prepared (see Table 6). The catalysts had three layers, wherein the first and third layers were identical. The middle layer was varied with regard to the catalyst carrier used, as shown in Table 6. Palladium to 4 wt % was dispersed on the catalyst carrier and calcined. The resulting Pd-catalyst carrier was then slurried with surfactant, barium acetate and oxygen storage component, then 20% palladium nitrate as post-addition dispersion over the slurry as described in Example 3, and washcoated onto a monolith that comprised a first layer. The monolith was then calcined. The third layer was then applied and the coated monolith was calcined.

All of the multi-layered catalysts prepared had a precious metal load of 30 g/ft³ with a precious metal ratio of 0/9/1 Pt/Pd/Rh (=0 g/ft³ Pt; 27 g/ft³ Pd; and 3 g/ft³ Rh. These catalysts were generally prepared as the multilayer catalysts were in Examples 3 and 5.

TABLE 6

| Catalyst | Catalyst carrier |
|---|---|
| Control catalyst 3 | Alumina |
| Catalyst 6 | 5% BaSO₄/Thermally |
| | stable Alumina |
| Catalyst 7 | 7.5% BaSO₄/Thermally |
| | stable Alumina |
| Catalyst 8 | 10% BaSO₄/Thermally |
| | stable Alumina |

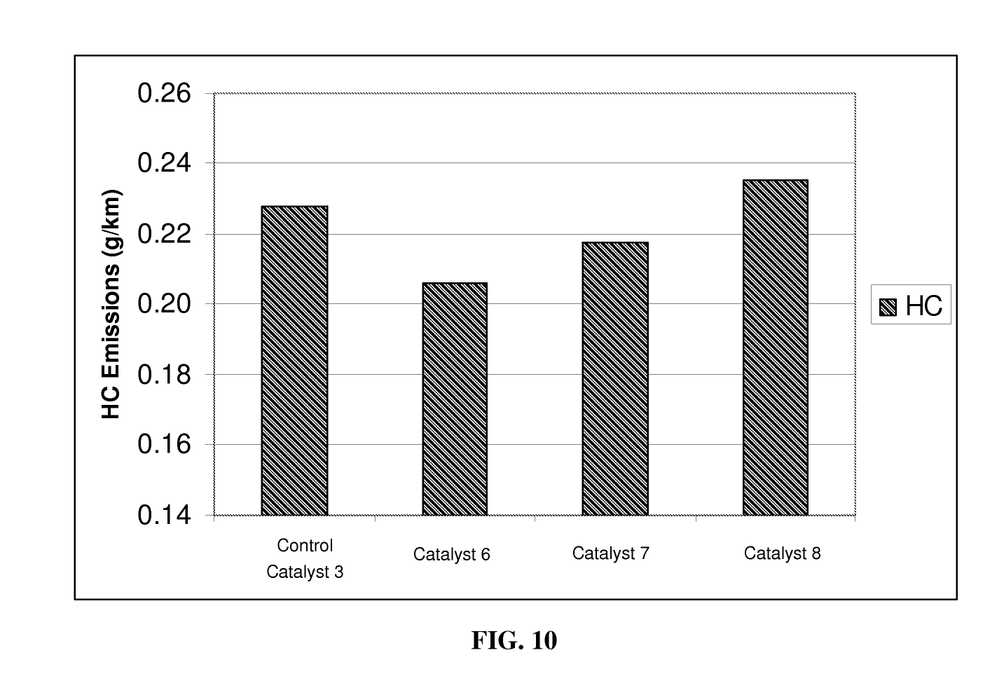

HC emissions were assessed post engine-aging at 1050° C. for 80 hours using the V265 European cycle. The data are depicted in FIG. 10. These data illustrate that a catalyst substrate comprising a catalyst carrier of alumina having less than about 10% BaSO₄ improves HC emissions post aging, compared to a catalyst substrate, Control Catalyst 3, comprising alumina alone (no BaSO₄) as catalyst carrier.

### Example 7

### Preparation of 4% Pd/3.5% BaSO₄/Thermally Stable Alumina Using Sulfuric Acid

To examine the need for a calcination step after impregnation of alumina with barium acetate, the following material was prepared.

Step 1. 3.5% BaSO₄/Thermally Stable Alumina (Single Calcination Step)

Large pore gamma alumina (98%, balance water) (228.0 kg) was treated with the following aqueous pre-mix, where salt is as wt % in water: 24% barium acetate (37.0 kg), diluted with DI water (62 kg). Rinse deionized (DI) water (2 kg) was used for transfer to the mixer. Impregnation was achieved by mixing for 20 minutes prior to transfer to proceeding to the next step. The barium acetate impregnated large pore alumina, which had not be calcined, was then treated with about 8.5% aq. sulfuric acid solution (5.8 kg, stoichiometric to BaO plus 70% excess) to about 90% incipient wetness point, and DI water (62.0 kg). Rinse DI water (2 kg) was used for transfer to the mixer. Impregnation and acid/salt reaction to form BaSO₄ was achieved by mixing for 20 minutes to give a 58% solids wet preparation. The impregnated material was then calcined (600° C.; time sufficient to remove substantially all water and any volatiles formed during reaction of barium acetate and acid) to produce the desired 3.5% BaSO₄/Thermally Stable Alumina product. Product form: powder to fine white granules; pH value slurry in water at 25° C.: 3; bulk density: 600-1,200 kg/m³.

Step 2. 4% Pd/3.5% BaSO₄/Thermally Stable Alumina

3.5% BaSO₄/Thermally Stable Alumina (98%, balance water) (66.71 kg) was treated with the following aqueous pre-mix, where salt is expressed as wt % in water: 20.63% palladium nitrate (13.20 kg), to about 90% incipient wetness point, and DI water (24.49 kg). Rinse DI water (2 kg) was used for transfer to the mixer. Impregnation was achieved by mixing for 20 minutes prior to transfer to a plastic drum (of a 64% solids wet preparation), from which the impregnated material was calcined to 600° C. (sufficient to remove substantially all water) to produce the desired 4% Pd/3.5% BaSO₄/Thermally Stable Alumina product (Sample 3). Product form: powder to fine brown-black granules; pH value slurry in water at 25° C.: 4; bulk density: 600-1,200 kg/m³.

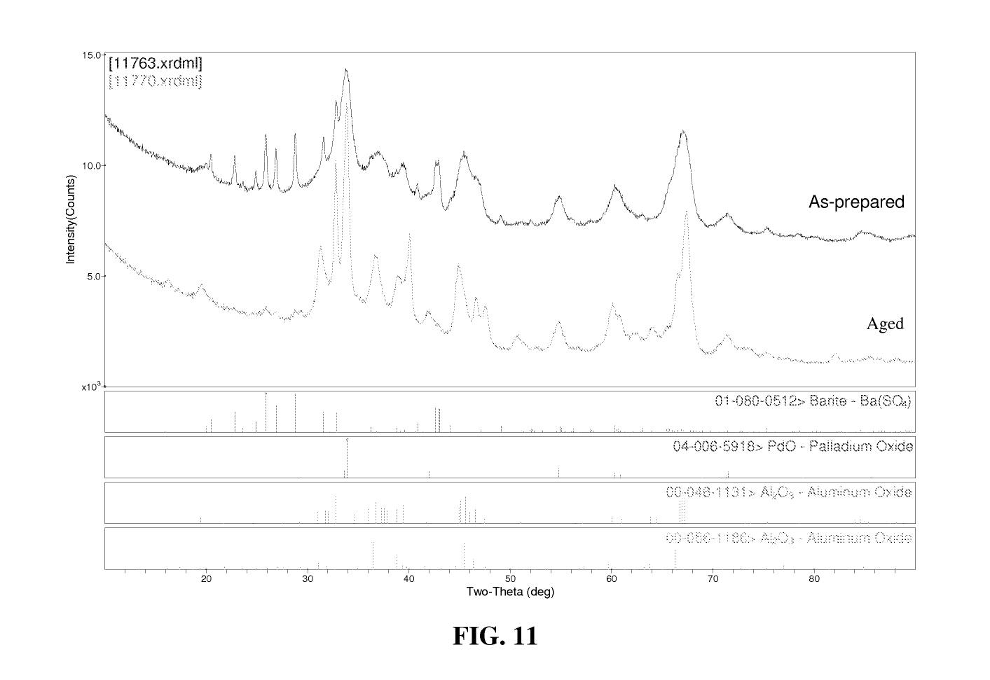

FIG. 11 provides two XRD patterns. The top line depicts is an XRD pattern for Sample 3 (4% Pd/3.5% BaSO₄/Thermally Stable Alumina) as prepared. The bottom line depicts an XRD pattern Sample 3 post aging by calcination in air at 1100° C. for 3 hours. The thermal stability of the product is shown in Table 7 below, indicated by formation of delta- and theta-alumina phases, and no alpha-alumina formation post-aging. These data indicate that BaSO₄/Thermally Stable Alumina catalyst carrier can be prepared without requiring a calcination step of barium acetate-impregnated material prior to treatment with sulfuric acid.

TABLE 7

| | | XRD Phases |
|---|---|---|
| | | (Incl. Transition |
| Sample | Sample Treatment | alumina) |
| 3 | Product As-prepared | transition alumina |
| | | (gamma, delta), |
| | | BaSO₄, PdO |
| 3, aged | Calcined in box oven at | transition alumina |
| | 1100° C./3 hr in air | (delta, theta), |
| | | BaSO₄, PdO, trace |
| | | Pd |

### Example 8

### Engine Data for Catalysts Comprising Sample 3 or Sample 1

Multi-layered catalysts, Catalysts 9 and 10, were prepared by washcoating substrates, wherein the middle coat was prepared using a catalyst slurry comprising either Sample 3 (4% Pd/3.5% BaSO₄/Thermally Stable Alumina; single calcination step in step 1; Catalyst 9) or Sample 1 (4% Pd/5% BaSO₄/Thermally Stable Alumina; two calcination steps in step 1; Catalyst 10). The other layers were identical between the two catalysts. Catalyst 9 and Catalyst 10 were arranged as the close-coupled catalyst in an emissions system consisting of a close-coupled catalyst followed by a downstream catalyst (Control Catalyst 4). See, e.g., FIG. 12A. Both Catalyst 9 and Catalyst 10 had a precious metal load 40 g/ft³; precious metal ratio 0/19/1 Pt/Pd/Rh=38 g/ft³ Pd and 2 g/ft³ Rh. Control Catalyst 4 had a precious metal load 3 g/ft³ with a precious metal ratio 0/2/1 Pt/Pd/Rh (=0 g/ft³ Pt; 2 g/ft³ Pd; and 2 g/ft³ Rh.

The emissions system was aged using a 4-mode cycle of temperature and air-to-fuel ratio during a 70 second cycle (Ford FNA again cycle; 2.3 L Fusion engine). The cycle was run continuously for 100 hours, after which emissions were tested using two different protocols: Federal Test Protocol 75 (FTP75) and US06. US06 employs a higher space velocity over the catalyst system, which is a more rigorous test of emissions abatement.

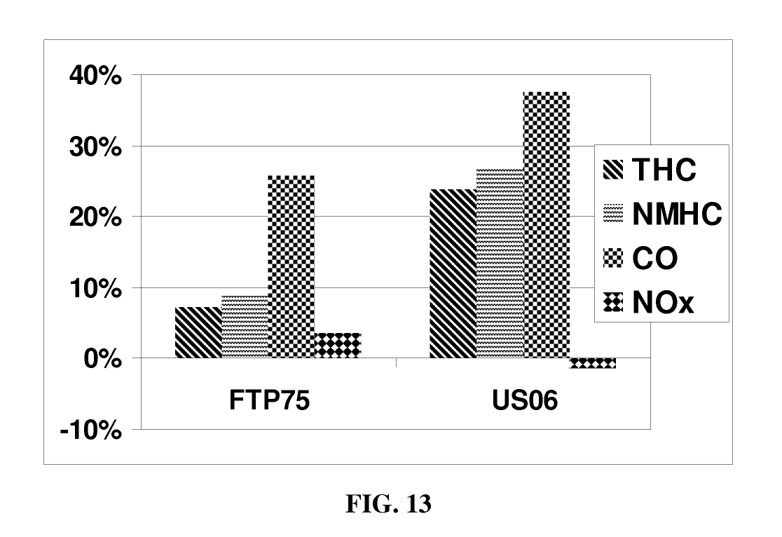

The relative emissions data are depicted in FIG. 13. The emissions of Catalyst 9 is better relative to Catalyst 10 for total hydrocarbon, non-methane hydrocarbon, carbon monoxide and nitrogen oxides under the FTP75 protocol. Under the US06 protocol having the higher space velocity, the improved emissions of Catalyst 9 relative to Catalyst 10 is more pronounced. Specifically, the emissions of Catalyst 9 is better relative to Catalyst 10 for total hydrocarbon, non-methane hydrocarbon, and carbon monoxide under the US06 protocol. Under the US06 protocol nitrogen oxides emissions were about the same or marginally less reduced for Catalyst 9 relative to Catalyst 10. These data indicate that the catalyst carrier having 3.5% barium sulfate and prepared as described in Example 7 exhibits improved hydrocarbon light-off catalyst activity.

The use of the terms “a” and “an” and “the” and similar referents in the context of describing the materials and methods discussed herein are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value can be incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the materials and methods and does not pose a limitation on the scope unless otherwise claimed. No language in the specification should be construed as indicating any non-claimed element as essential to the practice of the disclosed materials and methods.

All references, including publications, patent applications, and patents, cited herein are hereby incorporated by reference for all purposes to the same extent as if each reference were individually and specifically indicated to be incorporated by reference and were set forth in its entirety herein.

What is claimed is:

1. A catalyst carrier comprising a porous support and a barium sulfate layer dispersed on outer and inner surfaces of the porous support and chemically bonded thereto, wherein the catalyst carrier has a BET surface area of at least about 100 m²/g, and an average pore radius of about 80 Angstroms to about 150 Angstroms.

2. The catalyst carrier of claim 1, wherein the porous support is alumina.

3. The catalyst carrier of claim 2, wherein the alumina is selected from the group consisting of boehmite, gamma-alumina, delta-alumina, theta-alumina, and combinations thereof.

4. The catalyst carrier of claim 2, wherein the barium sulfate layer comprises barium sulfate in an amount of about 0.5% by weight to about 10% by weight.

5. The catalyst carrier of claim 4, further comprising a precious metal selected from the group consisting of platinum, palladium, rhodium, ruthenium, osmium, iridium, and combinations thereof.

6. The catalyst carrier of claim 5, which contains about 40% more precious metal active sites relative to porous support lacking a barium sulfate layer.

7. An emissions treatment system for an exhaust gaseous stream comprising a catalyst carrier according to claim 1.

8. The emissions treatment system of claim 7, wherein the catalyst carrier is disposed on a ceramic or metallic honeycomb flow-through substrate.

9. A process for preparing a catalyst carrier comprising the steps of:
a) providing a porous support comprising alumina (Al₂O₃) impregnated with barium oxide and/or barium carbonate;
b) treating the porous support with at least one molar equivalent of sulfuric acid based on barium oxide and/or barium carbonate, to produce a porous support having a barium sulfate layer dispersed on outer and inner surfaces of the porous support; and
c) optionally drying the porous support having the barium sulfate layer,
thereby forming the catalyst carrier.

10. The process of claim 9, wherein in step b) sulfuric acid is from about 1 molar equivalent to about 2 molar equivalents based on barium oxide and/or barium carbonate.

11. The process of claim 9, wherein the catalyst carrier has a BET surface area of at least about 100 m²/g, and an average pore radius of about 80 Angstroms to about 150 Angstroms.

12. The process of claim 9, wherein step a) is carried out at a temperature between about 500° C. and about 750° C.

13. The process of claim 9, further comprising the steps of:
d) impregnating the catalyst carrier with an aqueous precious metal salt solution to form an impregnated catalyst carrier; and
e) drying the impregnated catalyst carrier to provide a precious metal-containing catalyst carrier.

14. The process of claim 13, wherein the process excludes the step of drying the porous support having the barium sulfate layer prior to step d).

15. The process of claim 13, wherein the aqueous precious metal salt solution comprises a precious metal selected from the group consisting of platinum, palladium, rhodium, ruthenium, osmium, iridium and combinations thereof.
